(19) United States
(12) Patent Application Publication
(10) Pub. No.: US 2008/0285812 A1
(43) Pub. Date: Nov. 20, 2008

(54) Personal Identification Method and Apparatus

(75) Inventors: Wouter Harry Jacinth Rensen, Eindhoven (NL); Robert Frans Maria Hendriks, Eindhoven (NL); Michael Cornelis Van Beek, Eindhoven (NL); Antonius Hermanus Maria Akkermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,719

(22) PCT Filed: Apr. 28, 2005
(86) PCT No.: PCT/IB2005/051388

§ 371 Date: Nov. 6, 2006

(30) Foreign Application Priority Data
May 12, 2004 (EP) 04300274.0

(51) Int. Cl. G06K 9/00

(52) U.S. Cl. 382/115

(57) ABSTRACT

The invention relates to a personal identification method and to a corresponding apparatus. Their elements are mainly a light source emitting a beam of light towards a target, a first imaging module receiving a return beam coming back from said target and displaying an image of the target of a first type, and a second imaging module also receiving said return beam and displaying an image of the target of a second type. An identification module allows to combine the information given by said image of a first type and said image of a second type and to identify, or not, a person according to a similarity criterion.

### FIELD OF THE INVENTION

The invention relates to a personal identification method and to a corresponding apparatus.

### BACKGROUND OF THE INVENTION

The most frequently used solutions to secure data, transactions or access to physical objects such as buildings, computer systems, etc, rely on passwords or on hardware keys, for low-end applications. For medium security applications, fingerprint sensors are often preferred: the skin on the inside of a finger is covered with a pattern of ridges and valleys, and every person is believed to have unique fingerprints, which makes them suitable for verification of the identity of their owner. For high-end security applications, it is possible to use voice recognition, iris scans and the like, or also a combination of these methods. In fact, the preferred solution depends on various factors such as the security risks, the acceptable cost, the expected user compliance, the speed to use the device, or also the expected user acceptance.

The present invention (described in a following section) will be preferably used in medium security applications, where fingerprint sensors are popular for several reasons. First, fingerprint detection for security applications has been around for a long time and is widely accepted (fingerprints have been used successfully for about twenty years) and fingerprint sensors can be made at a cost relatively low. Moreover, fingerprint is not considered as highly invasive by the users, compared to other techniques such as voice recognition or iris scans (users experience a lower risk of damage to a finger by a fingerprint sensor than damage to an eye by an iris scan, and positioning a hand and finger is more comfortable than talking to a device or positioning one's hand and eyes in front of a device).

However, fingerprint sensors also suffer from a number of disadvantages. First, most sensors require a good physical contact for proper functioning, and it is therefore impossible to place them behind a shield protecting them from the environment (weather) or from an intentional destruction (vandalism). Moreover, these sensors are sensitive to sweat, grease (from fingers), dust and other contaminants, which can make them unreliable. Additionally, as people handle many different objects at many different locations, the fingerprints can easily be found and copied (spoofing), which is a serious limitation of the security level provided by fingerprint sensors (that would erroneously recognize a copied fingerprint).

### SUMMARY OF THE INVENTION

An object of the invention is therefore to propose a more reliable imaging method.

To this end, the invention relates to a method of identification comprising:

a transmission step, in which an optical beam is directed towards a target region of a body member;

a first imaging step, in which an image of the target region of a first type is displayed on the basis of a return beam coming back from said target region and separated from said optical beam;

a second imaging step, in which an image of the target region of a second type is displayed on the basis of an additional beam also coming back from said target region and separated from said optical beam and said return beam;

an identification step, in which information given by said image of a first type and information given by said image of a second type are combined for identifying, or not, the body member according to a similarity criterion based on a comparison with a reference.

In a preferred embodiment of the invention, the optical beam is obtained by means of a light emitting sub-step emitting said optical beam toward said target region, the return beam is obtained by means of a first splitting sub-step separating said return beam from said emitted optical beam and directing said return beam towards first imaging means, and the additional beam is obtained by means of a second splitting sub-step separating said additional beam from said optical beam and said return beam and directing said additional beam towards second imaging means.

Another object of the invention is to propose an identification apparatus for carrying out said method.

To this end, the invention relates to an identification apparatus comprising:

emitting means, in which an optical beam is emitted towards a target region of a body member;

first imaging means, in which an image of said target region of a first type is received and displayed on the basis of a return beam coming back from said target region and separated from said optical beam;

second imaging means, in which an image of said target region of a second type is received and displayed on the basis of an additional beam coming back from said target region and separated from said optical beam and said return beam;

identification means, in which information given by said first imaging means and information given by said second imaging means are received and combined for identifying, or not, the body member according to a similarity criterion based on a comparison with a reference.

In a preferred embodiment, said apparatus is provided for determining the identity of a user and comprises:

a) a light source emitting said optical beam;

b) an optical stage directing said optical beam towards a target region of the body of said user;

c) a polarizing beam splitter separating said return beam from said optical beam;

d) a first imaging module, receiving said return beam and displaying said image of a first type;

e) a second imaging module, receiving said additional beam and displaying said image of a second type;

f) an identification module, combining said information given by said image of a first type and said information given by said image of a second type and identifying, or not, said user according to said similarity criterion.

In another embodiment of the apparatus according to the present invention, it comprises:

a) a light source emitting said optical beam;

b) an optical stage directing said optical beam towards a target region of the body of said user;

c) a polarizing beam splitter separating said return beam from said optical beam;

d) a first imaging module, receiving said return beam and displaying said image of a first type;

e) a second imaging module, itself comprising a switchable quarter wave plate, said polarizing beam splitter and said first imaging module, for receiving said additional beam and displaying an image of the target region of a second type;

f) an identification module, combining said information given by said image of a first type and said information given by said image of a second type and identifying, or not, said user according to said similarity criterion.

In said embodiment, the switchable quarter wave plate is preferably a liquid crystal cell.

In still another embodiment of the apparatus according to the invention, it comprises:

a) a light source emitting said optical beam;

b) an optical stage directing said optical beam towards a target region of the body of said user;

c) a polarizing beam splitter separating said return beam from said optical beam;

d) a first imaging module, receiving said return beam and displaying said image of a first type;

e) a second imaging module, for receiving an additional return beam and displaying said image of the target region of a second type;

f) an identification module, combining said information given by said image of a first type and said information given by said image of a second type and identifying, or not, said user according to said similarity criterion;

said first and second image modules being properly aligned in order to constitute a stereoscopic imaging module capturing the same region of the target region under two different angles, and the differences between both images of a first and second type resulting in a three-dimensional view of the target region.

### BRIEF DESCRIPTION OF THE DRAWINGS

The present invention will now be described in greater detail hereinafter, with reference to the accompanying drawings in which:

FIG. 1 illustrates a conventional embodiment of the technique called OPSI in the description;

FIG. 2 illustrates an embodiment of an apparatus according to the present invention;

FIG. 3 illustrates another embodiment of an apparatus according to the invention;

FIG. 4 illustrates still another embodiment of an apparatus according to the invention.

### DETAILED DESCRIPTION OF THE INVENTION

The basis of the proposed imaging method is a technique called “Orthogonal Polarized Spectral Imaging” (OPSI). According to said technique, a semi-transparent target to be examined (for example a finger) is illuminated with a polarized light emitted by an excitation system such as a light emitting diode or a laser system, working generally in the near-infrared range, and an imaging system only detects light returning from said target with a polarization orthogonal to the polarization of the illuminating light. In this OPSI technique, the light that is reflected by the target surface will have the same polarization as the light illuminating said target, and therefore it will not be detected by the imaging system. On the contrary, the light that has been transmitted in the target (in the described example, in the skin and the finger) will scatter multiple times and will lose its original polarization direction. This depolarized light will now back illuminate the target (in the example, the blood vessels) and a part of said depolarized light will reach the imaging system. If there are within the target objects that absorb more light than the surrounding medium (for example, blood that absorbs more light than the surrounding tissue), the imaging system will record an image of dark objects in a brighter medium (for example, an image of dark blood vessels in a bright skin tissue).

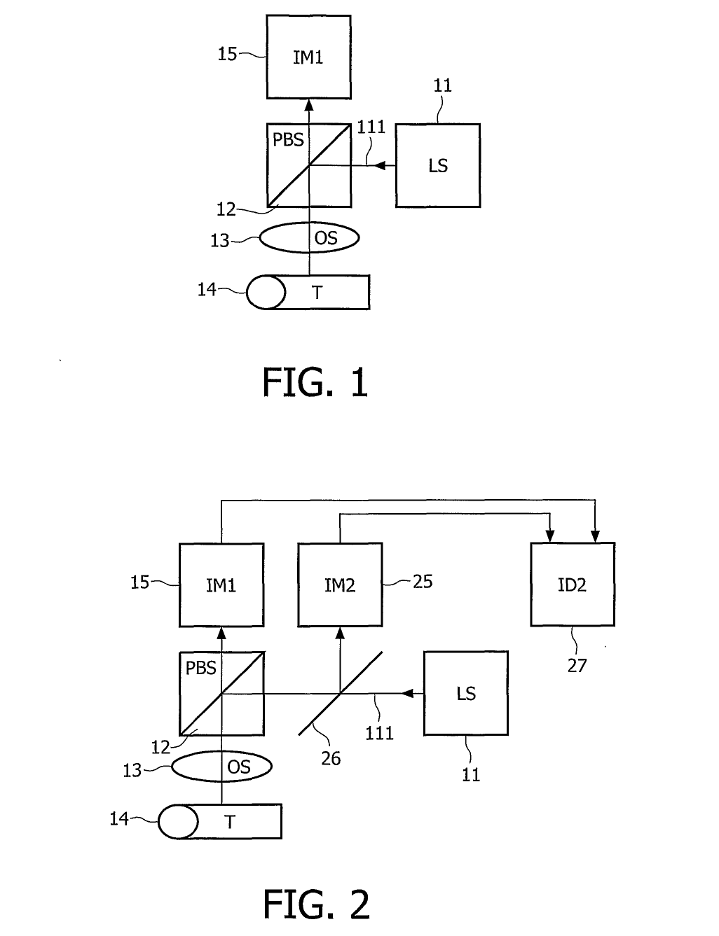

This basis principle of OPSI is illustrated in FIG. 1. The apparatus illustrated in said FIG. 1 comprises a light source 11 (LS), for instance a light emitting diode, emitting an optical imaging beam 111 that is collimated and directed towards a polarizing beam splitter 12 (PBS). The collimated imaging beam 111 is passed through the polarizing beam splitter 12, and the polarized imaging beam thus obtained is directed towards an optical stage 13 (OS) and then received by a target 14 (T), in the example, by the skin of a person. The light that has penetrated the target 14 (the skin) and scatters multiple times is depolarized and back illuminates the target and the objects within it (in the example, the blood vessels in the finger of the person). The polarization component orthogonal to the initial polarization is now collected by the optical stage 13, transmitted through the polarizing beam splitter 12, and finally recorded by an imaging module 15 (IM1). If the objects (in the example, the blood vessels) absorb the used wavelength more strongly than the surrounding medium, these objects (the blood vessels) appear dark in the captured image shown by the imaging module 15. The main features of such a system are already known, for instance from the U.S. Pat. No. 5,751,835.

A combination of a fingerprint detection method and the previously described technique then allows to eliminate the disadvantages associated with conventional fingerprint sensors and to perform a more reliable operation of fingerprint detection. An apparatus according to the invention, shown in FIG. 2 which illustrates a combination of the OPSI technique and the fingerprint imaging technique, first comprises the same modules as previously described with reference to FIG. 1 (the light source 11, the polarizing beam splitter 12, the optical stage 13, and the imaging module 15), but also, in the present embodiment, a second imaging; module 25 (IM2).

The first imaging module 15 is used as previously for OPSI, while the second one is used to image the fingerprint of the person. The light coming back from the target 14 (the finger of the person) with the original polarization mostly corresponds to a light that is reflected from the top layers of the target (the first skin layers). The polarizing beam splitter 12 reflects this light, and a beam splitter 26 located in the optical path between said polarizing beam splitter 12 and the light source 11 can redirect said returning light towards the second imaging module 25, able to record the fingerprint of the user. Thus the information based on blood vessels (available in the first imaging module 15) and the information based on the fingerprint (available in the second imaging module 25) can be combined in an identification module 27 (ID2), resulting in a more reliable biometric identification of the person.

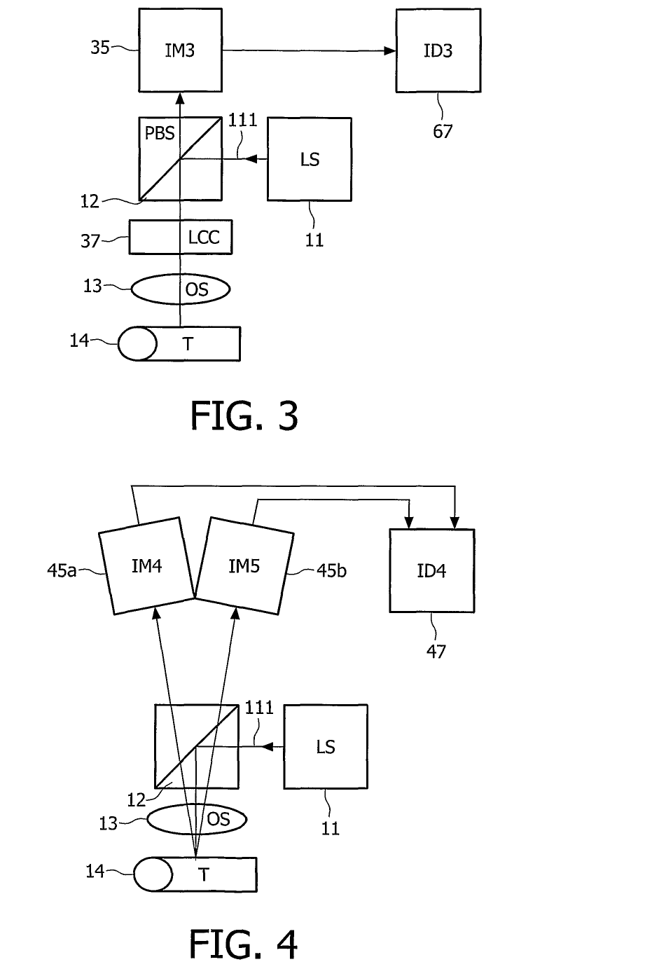

This disclosure is obviously illustrative and cannot be, in any way, a limitation of the scope of the invention. Modifications to the disclosed apparatus may also be proposed. For instance, in another embodiment illustrated in FIG. 3, which corresponds to a combination of OPSI and fingerprint imaging in which parts of the apparatus that are similar to the corresponding parts of the apparatus of FIGS. 1 and 2 (light source 11, polarizing beam splitter 12, optical stage 13) have identical references, only one imaging module 35 (IM3) is used for both OPSI and fingerprint imaging. For this purpose, a liquid crystal cell 37 (LCC1) is used as a switchable quarter wave plate:
when said quarter wave plate is switched off, the embodiment operates as an OPSI apparatus;
when the quarter wave plate is switched on, the polarization of light is rotated such as the same polarization as the illumination light is now transmitted to the imaging module 35. This way, said imaging module 35 will record mostly light that reflected from the first skin layers, which enables the imaging of the fingerprint of the person. The same reliable biometric identification of this person, based on a “blood vessel” information and a “fingerprint” information, is now possible and is done in an identification module 67 (ID3). The advantage of this embodiment is to save space and cost.

In another embodiment, illustrated in FIG. 4, which corresponds to a stereoscopic OPSI biometric system and in which parts of the apparatus that are similar to corresponding parts of previous embodiments have identical references (light source 11, polarizing beam splitter 12, optical stage 13), two imaging modules 45a (IM4) and 45b (IM5) are used to record blood vessels. If said modules are properly aligned, this results in a stereoscopic imaging system: the two imaging modules capture the same area, however under a different angle. The differences between both recorded images result in a 3D information related to the blood vessel pattern in the finger, which is used for identification of the person in an identification module 47.

The advantages of the invention described above are the following ones

(1) as the invention uses only optical methods to detect fingerprints and blood vessels, it is not necessary to have a mechanical contact between the sensor and the object (the finger): as a consequence, the sensor can be placed behind an optical window and will therefore be safe from outside influences (weather, vandalism) and will remain free of contaminants such as sweat, grease or dust (moreover, it is possible to have a single surface where the person places a finger, which increase the user-friendless, compared to inserting a finger into a device).

(2) the invention uses blood vessels for identification, which makes spoofing more difficult since users do not leave blood vessel patterns on any object they touch or handle (moreover, it is more difficult to construct a 3D blood vessel pattern compared to a fingerprint), and, by examining the spectral contrast, it is possible to discriminate between living and dead fingers, because the spectral absorption changes with the oxygenation of blood (access will be denied if the absorption of the light by the blood is different from what is expected from a reference database in the identification module).

It must be understood that the present invention is not limited to the aforementioned embodiments. Variations and modifications may be proposed without departing from the spirit and scope of the invention as defined in the appended claims, and the following closing remarks are made.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions, or that an assembly of items of hardware or software or both carry out a function. As said above, the description given with reference to the drawings illustrates rather than limits the invention, and numerous alternatives, which fall within the scope of the appended claims, are possible. The word “comprising” does not exclude the presence of other elements or steps than those listed in a claim. The word “a” or “an” preceding an element or step does not exclude the presence of a plurality of such elements or steps.

1. A personal identification method comprising:
a transmission step, in which an optical beam is directed towards a target region of a body member;
a first imaging step, in which an image of the target region of a first type is displayed on the basis of a return beam coming back from said target region and separated from said optical beam;
a second imaging step, in which an image of the target region of a second type is displayed on the basis of an additional beam also coming back from said target region and separated from said optical beam and said return beam;
an identification step, in which information given by said image of a first type and information given by said image of a second type are combined for identifying, or not, the body member according to a similarity criterion based on a comparison with a reference.

2. A method as claimed in claim 1, wherein said optical beam is obtained by means of a light emitting sub-step emitting said optical beam towards said target region.

3. A method as claimed in claim 2, wherein said return beam is obtained by means of a first splitting sub-step separating said return beam from said emitted optical beam and directing said return beam towards first imaging means and said additional beam is obtained by means of a second splitting sub-step separating said additional beam from said optical beam and said return beam and directing said additional beam towards second imaging means.

4. A personal identification apparatus comprising:
emitting means, in which an optical beam is emitted towards a target region of a body member;
first imaging means, in which an image of said target region of a first type is received and displayed on the basis of a return beam coming back from said target region and separated from said optical beam;
second imaging means, in which an image of said target region of a second type is received and displayed on the basis of an additional beam coming back from said target region and separated from said optical beam and said return beam;
identification means, in which information given by said first imaging means and information given by said second imaging means are received and combined for identifying, or not, the body member according to a similarity criterion based on a comparison with a reference.

5. A personal identification apparatus as claimed in claim 4, said apparatus being provided for determining the identity of a user and comprising:
a) a light source emitting said optical beam;
b) an optical stage directing said optical beam towards a target region of the body of said user;
c) a polarizing beam splitter separating said return beam from said optical beam;
d) a first imaging module, receiving said return beam and displaying said image of a first type;
e) a second imaging module, itself comprising a switchable quarter wave plate, said polarizing beam splitter and said first imaging module, for receiving said additional beam and displaying said image of a second type;
f) an identification module, combining said information given by said image of a first type and said information given by said image of a second type and identifying, or not, said user according to said similarity criterion.

6. A personal identification apparatus as claimed in claim 4, said apparatus being provided for determining the identity of a user and comprising:
a) a light source emitting said optical beam;
b) an optical stage directing said optical beam towards a target region of the body of said user;
c) a polarizing beam splitter separating said return beam from said optical beam;
d) a first imaging module, receiving said return beam and displaying said image of a first type;
e) a second imaging module, itself comprising a switchable quarter wave plate, said polarizing beam splitter and said first imaging module, for receiving said additional beam and displaying an image of the target region of a second type;
f) an identification module, combining said information given by said image of a first type and said information given by said image of a second type and identifying, or not, said user according to said similarity criterion.

7. An apparatus as claimed in claim 6, in which said switchable quarter wave plate is a liquid crystal cell.

8. An identification apparatus as claimed in claim 4, said apparatus being provided for determining the identity of a user and comprising:
a) a light source emitting said optical beam;
b) an optical stage directing said optical beam towards a target region of the body of said user;
c) a polarizing beam splitter separating said return beam from said optical beam;
d) a first imaging module, receiving said return beam and displaying said image of a first type;
e) a second imaging module, for receiving and additional return beam and displaying an image of the target of a second type;
f) an identification module, combining said information given by said image of a first type and said information given by said image of a second type and identifying, or not, said user according to said similarity criterion;
said first and second image modules being properly aligned in order to constitute a stereoscopic imaging module capturing the same region of the target region under two different angles, and the differences between both images of a first and second type resulting in a three-dimensional view of the target region.
